(19) United States
(12) Patent Application Publication
(10) Pub. No.: US 2025/0314737 A1
(43) Pub. Date: Oct. 9, 2025

(54) LOCATING METHOD

(71) Applicant: TOYOTA JIDOSHA KABUSHIKI KAISHA, Toyota-shi (JP)

(72) Inventor: Akito HARA, Nagoya-shi (JP)

(73) Assignee: TOYOTA JIDOSHA KABUSHIKI KAISHA, Toyota-shi (JP)

(21) Appl. No.: 18/986,748

(22) Filed: Dec. 19, 2024

(30) Foreign Application Priority Data
Apr. 3, 2024 (JP) 2024-059934

(51) Int. Cl. G01S 5/02

(52) U.S. Cl. CPC G01S 5/02524

(57) ABSTRACT

A radio wave receiver installed in the vehicle receives a radio wave transmitted from each radio wave transmitter. Using the received radio wave correction amount, the radio wave strength is attenuated and amplified with respect to the strength of the received radio wave, and the radio wave strength is artificially increased or decreased. The calculated strength of the radio wave from each radio wave transmitter is compared with the fingerprint to identify the grid cell having the most similar pattern of the radio wave strength as the tentative current position. Identify the area that contains the identified grid cell number. The position of the vehicle is determined using the machine learning model created for the identified area.

### CROSS-REFERENCE TO RELATED APPLICATION

This application claims priority to Japanese Patent Application No. 2024-059934 filed on Apr. 3, 2024, incorporated herein by reference in its entirety.

### BACKGROUND

### 1. Technical Field

The disclosure relates to a locating method. In particular, the disclosure relates to improvement for increasing precision of identifying locations of objects to be located.

### 2. Description of Related Art

Conventionally, the Global Positioning System (GPS) and so forth have been used as technology for identifying a location of an object (for example, an own vehicle) outdoors. Note that as for technology for locating in an indoor place where such GPS or the like cannot be used (e.g., locating of a shipping truck in a shipping warehouse, or the like), a locating method of a fingerprinting method using Bluetooth is known (see Japanese Unexamined Patent Application Publication No. 2004-500566 (JP 2004-500566 A)).

In the technology for identifying locations by the fingerprinting method, a plurality of radio wave transmitters (e.g., Wi-Fi access points) is installed in a subject space and also the subject space is sectioned into a plurality of grid cells, and strength (received signal strength indicator (RSSI)) of radio waves from the radio wave transmitters is measured at each point for each grid cell, thereby creating a fingerprint (RSSI map) of RSSI. The strength of the radio waves from each radio wave transmitter (the strength of the individual radio waves identified for each radio wave transmitter) received by the radio wave receiver installed in an object (object to be located) is compared with the fingerprint. Thus, a grid cell having the most similar pattern of strength of radio waves received from each radio wave transmitter from among the grid cells of the fingerprint is identified (positioned) as the grid cell in which the object to be located is currently situated.

### SUMMARY

However, the locating technology according to the conventional fingerprinting method is limited to precision of a level of obtaining which grid cell the location of the object to be located is in, and cannot identify the location with further precision.

The disclosure has been made in view of the above problems, and an object thereof is to provide a locating method that enables precision of identifying locations of objects to be located to be improved.

A solution according to the disclosure for achieving the above object presumes a locating method for identifying a position of an object to be located, using a fingerprint. The locating method includes

individually creating a machine learning model for predicting coordinate values based on strength of radio waves received from each of a plurality of radio wave transmitters, with respect to each of a plurality of areas divided in advance,
identifying an area in which the object to be located is situated, out of the plurality of areas, based on the strength of the radio waves received by a radio wave receiver provided to the object to be located, and
identifying coordinate values of the object to be located in the area that is identified, using the machine learning model that is created for the area that is identified.

According to this specific matter, the area in which the object to be located is situated is identified based on the strength of the radio waves received by the radio wave receiver provided in the object to be located, following which the coordinate values (the location of the object to be located in the area) of the object to be located in the area is identified using the machine learning model created for the area. Accordingly, as compared with when the location of the object to be located is identified by the fingerprinting method without dividing the space into multiple areas (when the coordinate values of the object to be located are identified by one model for the entire space), the coordinate values (location) of the object to be located is identified using a machine learning model dedicated to a narrowed-down area, and hence the precision of identifying the location of the object to be located can be improved.

Also, in the identifying of the area, a grid cell in which the object to be located is situated is identified based on a fingerprint created for a plurality of grid cells sectioned in each of the plurality of areas, following which an area to which the grid cell that is identified belongs is identified as an area in which the object to be located is situated.

This enables the area for selecting the machine learning model to be narrowed down with high precision, thereby suppressing erroneous recognition of the area, and improving the precision of identifying the location of the object to be located.

Also, in the identifying of the area, a degree of similarity among patterns of strength of radio waves received from each radio wave transmitter is found for each grid cell of the fingerprint, a grid cell in which the object to be located is situated is found by performing weighted averaging processing of the degree of similarity, and the area including the grid cell is identified as the area in which the object to be located is situated.

This enables identifying of the area in which the object to be located is situated, by effectively using the locating technology of the existing fingerprinting method, and thus the area in which the object to be located is situated can be identified effectively.

Also, in the identifying of the area, a received radio wave correction amount based on an external factor affecting a radio wave reception state of the radio wave receiver is used to correct the strength of the radio waves received from the radio wave transmitter to a strength of the radio waves when assuming that the external factor does not exist, following which the degree of similarity is calculated.

This enables adverse effects on locating precision caused by external factors to be removed, and precision of identifying the location of the object to be located can be improved.

According to the disclosure, a machine learning model is individually created for each of multiple areas divided in advance, an area in which an object to be located is situated is identified based on strength of radio waves received by a radio wave receiver, and coordinate values of the object to be located are identified using a machine learning model created for the identified area. Accordingly, as compared with when a location of the object to be located is identified by a fingerprinting method without dividing the space into multiple areas, the coordinate values of the object to be located are identified using a machine learning model dedicated to a narrowed-down area. This enables precision of identifying the location of the object to be located to be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing each grid cell sectioned into a shipping warehouse in an embodiment;

FIG. 2 is a plan view showing each area sectioned in a shipping warehouse;

FIG. 3 is a flow chart diagram illustrating a locating procedure;

FIG. 4 is a view corresponding to FIG. 1 showing an example of a current position of a vehicle in a shipping warehouse;

FIG. 5 is a diagram corresponding to FIG. 1 illustrating an exemplary position of a vehicle temporarily identified in an area-identifying process in an imaginary line; and

FIG. 6 is a plan view of an area A showing an example of the position of the vehicle identified in the locating process.

### DETAILED DESCRIPTION OF EMBODIMENTS

Hereinafter, an embodiment of the present disclosure will be described with reference to the drawings. The present embodiment describes a case where the present disclosure is applied as a locating method for identifying a position of a vehicle (a shipping truck or the like) traveling in a shipping warehouse.

### Description of Each Grid Cell and Each Area

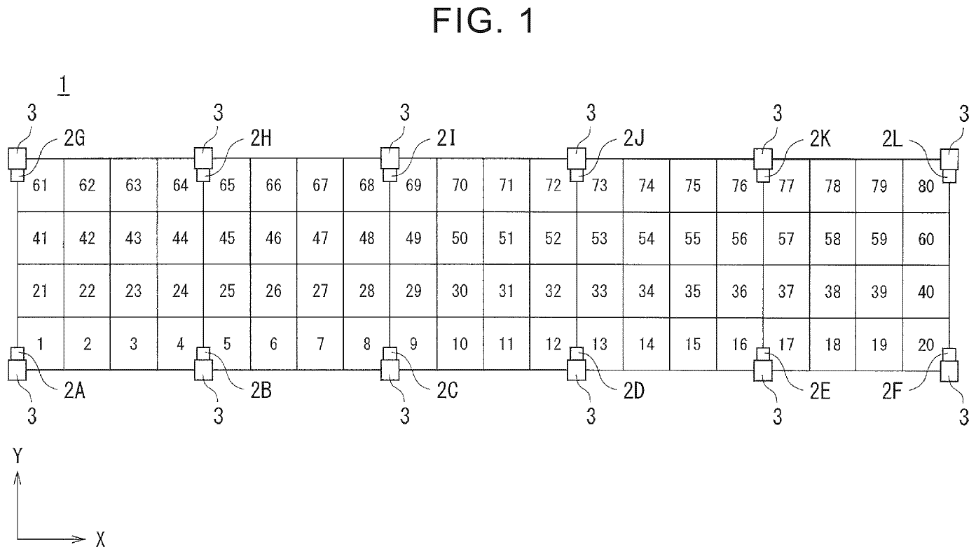

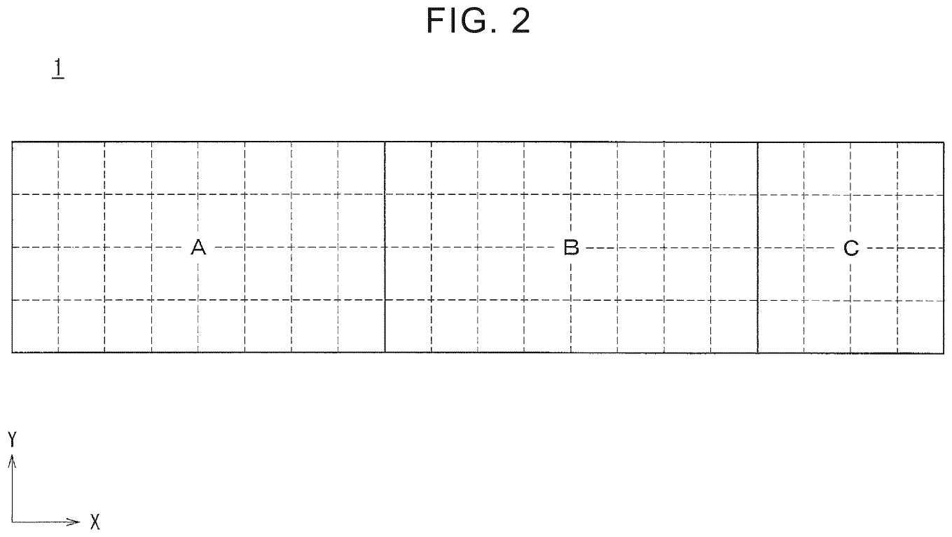

The shipping warehouse is sectioned into a plurality of grid cells and a plurality of areas. FIG. 1 is a plan view showing each grid cell sectioned in a shipping warehouse 1. FIG. 2 is a plan view showing each area sectioned in the shipping warehouse 1. For example, the length in the X direction of the shipping warehouse 1 is 100 m, and the length in the Y direction is 20 m. The size of the shipping warehouse 1 is not limited thereto.

As shown in FIG. 1, in the present embodiment, the shipping warehouse 1 is sectioned into a total of 80 grid cells of 20 in the X direction and 4 in the Y direction. In the following description, for convenience, each grid cell is given a number (grid cell number). The numbers 1 to 80 in each grid cell in FIG. 1 are the grid cell numbers assigned to the respective grid cells. In the present embodiment, the dimension in the X direction and the dimension in the Y direction of each grid cell are substantially the same, but these dimensions are not necessarily the same. Further, the shape of each grid cell in plan view is not necessarily a quadrangular shape.

As shown in FIG. 2, in the present embodiment, the shipping warehouse 1 is sectioned into three areas. In the present embodiment, an area including grid cells (32 grid cells) having grid cell numbers 1 to 8, 21 to 28, 41 to 48, 61 to 68 is referred to as an “A area”. Further, an area including each grid cell (32 grid cells) having grid cell numbers 9 to 10 16, 29 to 35, 49 to 56, 69 to 76 is referred to as a B area. Further, an area including each grid cell (16 grid cells) having grid cell numbers 17 to 20, 37 to 40, 57 to 60, 77 to 80 is referred to as a C area. The letters A to C shown in the respective areas in FIG. 2 are area indications assigned to the respective areas. The number of areas and the number of grid cells included in each of the areas A to C are not limited thereto. In addition, the shape of each area in plan view is not necessarily a quadrangular shape.

A 2L is installed from a radio wave transmitter 2A at a plurality of locations in the shipping warehouse 1. In the present embodiment, one radio wave transmitter 2A (2B to 2L) is attached to each column 3, 3 . . . erected in the shipping warehouse 1, and radio waves are transmitted from each of the radio wave transmitters 2A to 2L toward the space in the shipping warehouse 1. In the present embodiment, the strengths of the radio waves transmitted from the respective radio wave transmitter 2A from 2L are set to be the same. The strength of the radio waves transmitted from 2L from the respective radio wave transmitter 2A may be different from each other.

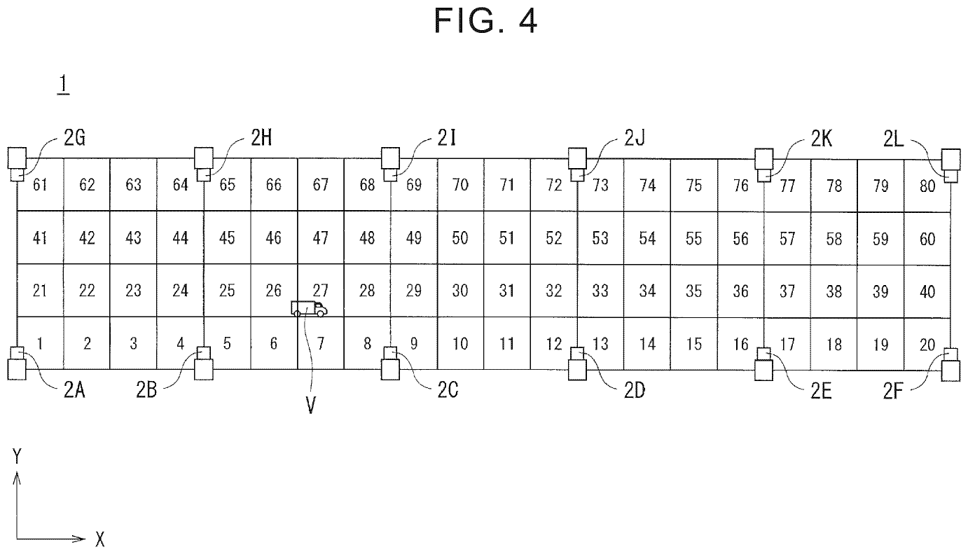

In the shipping warehouse 1, the strength of radio waves from the respective radio wave transmitter 2A to 2L is measured at each point for each grid cell (for each grid cell of grid cell numbers 1 to 80). As a result, a fingerprint of the radio wave strength representing the strength of the individual radio waves identified for each 2L from the radio wave transmitter 2A at each of the respective points is created. This is, as is well known, to identify a grid cell in which vehicle V is located according to the degree of similarity in the pattern of strength of the radio waves received from 2L from each radio wave transmitter 2A from the radio wave receiver installed in the vehicle V (see FIG. 4) out of each grid cell of the fingerprint (each grid cell from grid cell number 1 to 80) by matching the strength of the radio waves from 2L from each radio wave transmitter 2A to the fingerprint.

In the present embodiment, individual machine learning models are created for each of the areas A to C. That is, for each of the areas A to C, the teacher data (the teacher data of the relation between the coordinate values in the range corresponding to each of the areas A to C and the strength of the radio waves received from each of the radio wave transmitter 2A from 2L) is acquired and learned (the strength of the radio waves received from each of the radio wave transmitter 2A from 2L is learned). Further, a machine learning model is created for predicting coordinate values from the strength of radio waves received from the respective 2L from the respective radio wave transmitter 2A. That is, in each of the area A, the area B, and the area C, a machine learning model dedicated to each area and different from each other is created. Note that the dedicated machine learning models for the respective areas may be created by acquiring and learning teacher data including the strength of radio waves received from a plurality of radio wave transmitters (for example, the radio wave transmitter 2A, 2B, 2C, 2G, 2H, 2I in the case of the A area) located within the range of the respective areas. The area-specific machine learning model may be a model created by acquiring and learning the teacher data including the strength of the radio waves received from 2L from all the radio wave transmitter 2A.

This machine learning model identifies grid cells included in the respective areas from the strength of the radio waves received from the respective 2L from the respective radio wave transmitter 2A. In addition, the machine learning model is created to predict the position of the vehicle V in the grid cell (more specifically, the position of the radio wave receiver installed in the vehicle V in the grid cell).

Further, the vehicles V are equipped with radio wave receivers (not shown) capable of receiving radio waves transmitted from 2L from the respective radio wave transmitter 2A. The radio wave receiver is influenced by a receiving state of radio waves depending on an installing position of a loading platform or a load in the vehicle V. For example, in a case where the radio wave receiver is installed in the vicinity of the loading platform of the vehicle V, the influence of inhibiting the reception of the radio waves due to the presence of the loading platform differs depending on the positional relationship between the radio wave receiver and the loading platform, the size of the loading platform (including the installed state of the load), and the like. That is, when the platform or the load is situated in the space between the radio wave receiver installed in the vehicle V and 2L from the radio wave transmitter 2A, the reception of the radio waves is hindered. The space between the radio wave receiver and the radio wave transmitter 2A and 2L is different from each other in a condition in which reception of radio waves in the radio wave receiver is hindered for each 2L from the radio wave transmitter 2A such as a combination in which a load bed or a load is situated between them, a combination in which a load bed or a load is not situated, or a combination in which a load bed or a load is situated only in a part of the space.

The vehicle V stores, as individual information, information relating to the effect of the reception status of radio waves caused by external factors such as the charge platform, as the received radio wave correcting amounts corresponding to the respective radio waves received from the respective radio wave transmitter 2A from 2L. The received radio wave correcting amount is for correcting the strength of the radio wave actually received from 2L from the respective radio wave transmitter 2A (the strength of the radio wave affected by the external factor) to the strength of the radio wave when it is assumed that there is no external factor such as a charge platform. Further, the received radio wave correction amount is obtained by setting the correction amount to be larger as the influence of the external factor on the reception of the radio wave is larger. In addition, the received radio wave correction amount is obtained for each vehicle (for each type of vehicle or for each installed state of a load in the vehicle) by an experiment or a simulation in advance. Specifically, the received radio wave correction amount is obtained by calculating the attenuation amount and the amplification amount of the radio wave strength due to the diffraction, reflection, or the like of the radio wave due to an external factor such as the charging platform.

It is assumed that the loading state of the cargo on the cargo bed of the vehicle V changes due to loading and unloading of the cargo in the shipping warehouse 1. Therefore, it is preferable to change the received radio wave correction amount in accordance with loading and unloading of the cargo. At this time, the information on the installed state corresponding to the loading and unloading of the cargo may be acquired by an input operation by the driver of the vehicle V. Further, the information on the installed state corresponding to the loading and unloading of the baggage may be configured such that sensors capable of acquiring the information on the installed state of the baggage are installed in the vehicle V, and the received radio wave correction amount is changed based on the information acquired by the sensors.

Various kinds of information such as the fingerprint, the machine learning model, and the received radio wave correction amount described above may be stored in a locating device (not shown) installed in the vehicle V. Further, various kinds of information such as the fingerprint, the machine learning model, and the received radio wave correction amount described above may be stored in a management server (not shown) that manages the traveling positions of one or a plurality of vehicles V traveling in the shipping warehouse 1. Further, a part of the various kinds of information may be stored in a locating device installed in the vehicle V, and other information may be stored in the management server, so that various kinds of information may be shared by mutual communication between the vehicle V and the management server.

### Locating Processing

Next, the process of locating in the present embodiment will be described.

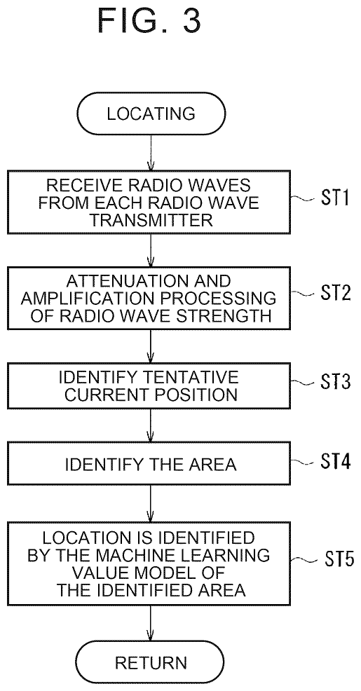

FIG. 3 is a flowchart illustrating a procedure of locating. The machine learning model is created in correspondence with each of the area A, the area B, and the area C before the locating is performed (corresponding to a step of individually creating a machine learning model for predicting a coordinate value based on the strength of radio waves received from each of a plurality of radio wave transmitters for each of a plurality of pre-divided areas in the present disclosure). Further, the received radio wave correction amount in the vehicle V is calculated.

Here, a case will be described in which, when the actual position of the vehicle V is in the lower left portion of the drawing at the grid cell number 27 as shown in FIG. 4, this position is identified with high precision as an example.

First, in ST1, radio wave receivers installed in vehicles V receive radio waves transmitted from 2L from respective radio wave transmitter 2A. Thus, the strength of the radio waves received from each radio wave transmitter 2A from 2L is measured from each radio wave transmitter 2A for each 2L.

Then, in ST2, the strength of the radio waves received by ST1 is attenuated and amplified by using the received radio wave correcting quantity, and the radio wave strength is artificially increased or decreased. That is, the radio wave strength obtained by eliminating the influence of the reception state of the radio waves due to an external factor such as the platform, and used for locating the vehicle V without being affected by the external factor, is calculated.

In ST3, the strength of the radio waves from each of the radio wave transmitters 2A to 2L calculated by ST2 (the strength of the radio waves calculated by using the received radio wave correction amount) is compared with the fingerprint created for the whole of the shipping warehouse 1, and thereby, the grid cell in which the pattern of the strength of the radio wave received from each radio wave transmitter 2A from 2L is most similar among the respective grid cells of the fingerprint (the respective grid cells of the grid cell numbers 1 to 80) is identified as the temporary present position.

At this time, in order from the grid cell having a high degree of similarity in the pattern of the strength of the radio waves among the grid cells, the degree of similarity is obtained such as the first candidate grid cell, the second candidate grid cell, and the third candidate grid cell, and a weighted average process corresponding to the degree of similarity is performed on these grid cells to identify the provisional current position of the vehicle V.

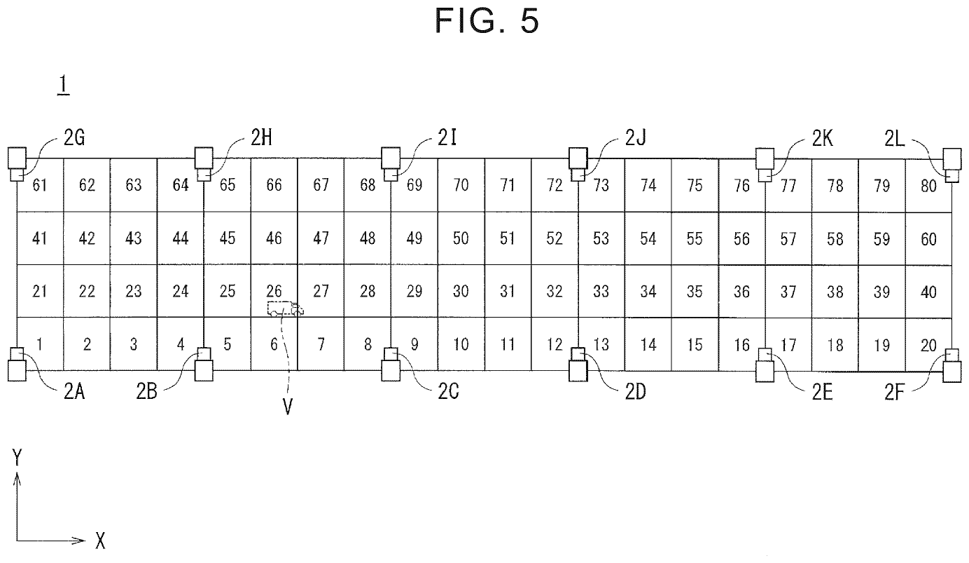

FIG. 5 shows a case where the position of the vehicle V identified in this way is the lower right portion in the drawing at the grid cell number 26. For example, when the first candidate grid cell is the grid cell number 27, the second candidate grid cell is the grid cell number 26, and the third candidate grid cell is the grid cell number 5, the provisional current position of the vehicle V may be identified as shown in FIG. 5. In FIG. 5, since the position of the identified vehicle V is a temporary position, the vehicle V is represented by an imaginary line.

In ST4, an area including the grid cell number (26 in the above-described process) identified by ST3 is identified from the area A to the area C. In the above-described processing, since the tentative current position is identified by the grid cell number 26, the area A is identified here.

In ST3 and ST4, the above processes are performed. As a result, these processes are area identifying processes. This processing corresponds to “a step of identifying an area in which the object to be located is situated among a plurality of areas based on the strength of the radio waves received by the radio wave receiver provided in the object to be located”.

In ST5, the position of the vehicle V is identified by using the machine learning model created for the area identified by the area identifying process. In this locating process, as in ST2 described above, the received radio wave correcting amount is used to attenuate and amplify the radio wave strength with respect to the strength of the received radio wave, thereby pseudo increasing or decreasing the radio wave strength, and the radio wave strength obtained by eliminating the effect of the reception status of the radio waves due to an external factor such as a charging platform is calculated. Note that the information of the radio wave strength calculated by ST2 may be stored, and the information may be used as it is.

By applying the calculated radio wave strength to the machine learning model (the machine learning model created for the area identified by the area identification processing), the current position of the vehicle V in this area is identified. The process in this ST5 corresponds to the “steps of identifying the coordinate values of the object to be located in the identified area using the machine learning model created for the identified area”.

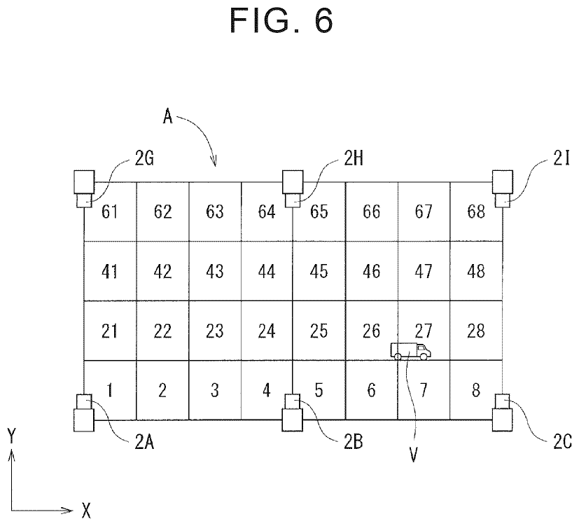

Since the area A is identified in the above-described processing, the position of the vehicle V is identified using the machine learning model created for the area A. FIG. 6 shows a case where the position of the vehicle V identified for the area A in this way becomes the lower left portion in the drawing at the grid cell number 27.

### Effects of Embodiment

As described above, in the present embodiment, the area in which the vehicle V is situated is identified from the strength of the radio wave received by the radio wave receiver installed in the vehicle V, and then the coordinate value of the vehicle V in the area is identified using the machine learning model created for the area. That is, as compared with a case where the coordinate value of the vehicle V is identified by a fingerprinting method for the entire space including a plurality of areas (a case where the coordinate value of the vehicle V is identified by one model for the entire space), the coordinate value of the vehicle V is identified by using a machine learning model dedicated to the narrowed-down area and the area. As a result, it is possible to improve the precision of identifying the position of the vehicle V.

Further, in the present embodiment, the grid cell in which the vehicle V is situated is identified based on the fingerprints created for the plurality of grid cells sectioned in each of the plurality of areas, and then the area to which the identified grid cell belongs is identified as the area in which the vehicle V is situated. Therefore, erroneous recognition of the area where the vehicle V is situated can be suppressed, and the precision of identifying the position of the vehicle V can be increased.

In addition, in the present embodiment, for each grid cell of the fingerprint, the degree of similarity of the strength pattern of the radio waves received from 2L from the respective radio wave transmitter 2A is determined and the grid cell in which the vehicle V is situated is determined by performing weighted average processing of the degree of similarity to identify the area in which the grid cell is included as the area in which the vehicle V is situated. Therefore, it is possible to identify the area in which the vehicle V is situated by effectively using the locating technology of the existing fingerprinting method, and thus it is possible to identify the area in which the vehicle V is situated effectively.

Further, in the present embodiment, the strength of the radio wave received from the radio wave transmitter is corrected to the strength of the radio wave when it is assumed that the external factor does not exist by using the received radio wave correction amount based on the external factor that affects the radio wave reception state of the radio wave receiver, and then the degree of similarity is calculated. Therefore, it is possible to eliminate an adverse effect on the position specifying precision caused by an external factor, and it is possible to improve the identifying precision of the position of the vehicle V.

### Other Embodiments

It should be noted that the present disclosure is not limited to the embodiment above, and all modifications and applications included in the scope of claims and a range equivalent to the scope of claims are possible.

For example, in the above embodiment, a case has been described in which the present disclosure is applied as a locating method for identifying the position of the vehicle V traveling in the shipping warehouse 1. The present disclosure is not limited to this, and can be applied to a case where a position of an object to be located is identified in various indoors.

Further, in the above embodiment, the case where the object to be located is a shipping truck traveling in the shipping warehouse 1 has been described as an example. The present disclosure is not limited to this, and can be applied to a case where an object to be located is a forklift that travels in the shipping warehouse 1. In this case, the reception state of the radio wave in the radio wave receiver is affected by the size of the load carried by the forklift and the elevating position of the fork. Therefore, it is preferable to change the received radio wave correction amount based on the information on the size of the load and the lifting position of the fork. At this time, the information on the size of the load and the lifting position of the fork may be acquired by an input operation performed by the driver of the forklift. Further, the information on the size of the load and the elevating position of the fork may be configured such that sensors capable of acquiring information on the size of the load and the elevating position of the fork are installed in the forklift, and the received radio wave correction amount is changed based on the information acquired by the sensors.

Further, in the above embodiment, as each area sectioning the shipping warehouse 1, the area A and the area B are the same area, and the area C is an area smaller in area than the area A and the area B. The present disclosure is not limited to this, and all areas may have the same area, or all areas may have different areas.

Further, in the above-described embodiment, the arrangement form of 2L from the radio wave transmitter 2A installed in the shipping warehouse 1 is symmetrical with respect to the center position in the X direction in the X direction in the shipping warehouse 1. In addition, in the Y direction of the shipping warehouse 1, it is symmetrical with respect to the center position in the Y direction. The present disclosure is not limited to this, and the arrangement of 2L from the radio wave transmitter 2A in the respective directions may be asymmetric.

The present disclosure is applicable to a locating method for identifying a location of a shipping truck traveling in a shipping warehouse.

What is claimed is:

1. A locating method that uses a fingerprint to identify a location of an object to be located, the locating method comprising:
individually creating a machine learning model for predicting coordinate values based on strength of radio waves received from each of a plurality of radio wave transmitters, with respect to each of a plurality of areas divided in advance;
identifying an area in which the object to be located is situated, out of the plurality of areas, based on the strength of the radio waves received by a radio wave receiver provided to the object to be located; and
identifying coordinate values of the object to be located in the area that is identified, using the machine learning model that is created for the area that is identified.

2. The locating method according to claim 1, wherein, in the identifying of the area, a grid cell in which the object to be situated is located is identified based on a fingerprint created for a plurality of grid cells sectioned in each of the plurality of areas, following which an area to which the grid cell that is identified belongs is identified as an area in which the object to be located is situated.

3. The locating method according to claim 2, wherein, in the identifying of the area, a degree of similarity among patterns of strength of radio waves received from each radio wave transmitter is found for each grid cell of the fingerprint, a grid cell in which the object to be located is situated is found by performing weighted averaging processing of the degree of similarity, and the area including the grid cell is identified as the area in which the object to be located is situated.

4. The locating method according to claim 3, wherein, in the identifying of the area, a received radio wave correction amount based on an external factor affecting a radio wave reception state of the radio wave receiver is used to correct the strength of the radio waves received from the radio wave transmitter to a strength of the radio waves when assuming that the external factor does not exist, following which the degree of similarity is calculated.
